(19) United States
(12) Patent Application Publication
(10) Pub. No.: US 2012/0079930 A1
(43) Pub. Date: Apr. 5, 2012

(54) DEVICE FOR EXTRACTING A LIQUID CONTAINED IN CONTAINERS MADE OF AN INFRANGIBLE MATERIAL

(75) Inventors: Nicolas Laurent, Reims (FR); Rémi Gomez, Paris (FR); Michel Degrange, Paris (FR); Jean-Marc Meurville, Nailly (FR)

(73) Assignee: ARTS, Paris (FR)

(21) Appl. No.: 13/262,271

(22) PCT Filed: Mar. 26, 2010
(86) PCT No.: PCT/EP2010/054013

§ 371 Date: Dec. 14, 2011

(30) Foreign Application Priority Data
Mar. 30, 2009 (FR) 09 01525

(51) Int. Cl. B23D 19/04

(52) U.S. Cl. 83/495

(57) ABSTRACT

The invention relates to a device for extracting a liquid (14) contained in a container (12, 13, 15) of non-brittle material such as a container containing a liquid or pasty cosmetic or food product. The device comprises two wheels (1, 2) rotating about parallel axes (AX1, AX2) and separated from each other by a gap (E), together with motor means (3) for driving the two wheels (1, 2) in rotation in opposite directions. At least one of the wheels (1, 2) includes spikes (7, 11) projecting radially from an outer base diameter of the wheel (D1, D2) and engaging in corresponding recesses in the other wheel (1, 2; 21). The device serves simultaneously to compress and to pierce the containers (12, 13, 15) when they pass through the gap (E) between the two wheels.

The invention relates to reprocessing liquid or pasty substances that have been packaged in containers made of flexible material, and that are found to be unsuitable for sale.

### BACKGROUND OF THE INVENTION

In the field of fabricating various products, such as cosmetics, liquid soaps, food products of the soup, fruit juice, or soda type, products are packaged in containers that are usually made of plastics material, aluminum cans, or indeed card boxes.

After being packaged in containers, it can be found that the product for one reason or another is in fact unsuitable for sale, and that it needs to be discarded. In this context, given the ever increasing financial and ecological imperatives in industry, it is necessary to separate the packaged substance from the container that contains it.

In such a situation, which is not usual and which is undesired, the substances are extracted by operators opening each container in order to empty it, and that can turn out to be extremely time-consuming and expensive, given the robustness of the closure means used for containers.

### OBJECT OF THE INVENTION

The object of the invention is to provide a solution for facilitating the operation of extracting the substance contained in such containers.

### SUMMARY OF THE INVENTION

To this end, the invention provides a device for extracting a liquid or pasty substance contained in a container of non-brittle material, such as a container containing a cosmetic or food product, the device comprising two wheels rotating about parallel axes while being separated from each other by a gap, motor means for driving these two wheels in rotation in opposite directions, at least one of the wheels including spikes that project radially, the other wheel having recesses constituting hollow portions for receiving the spikes when they are in the gap, thereby together compressing and piercing each container passing through the gap.

With this solution, it is no longer necessary for an operator to open each container in order to empty out its content, since this operation is performed completely automatically, and it enables the content and the container to be separated effectively.

The invention also provides a device as defined above, wherein one of the wheels is a driving wheel that is driven directly by the motor means, and the other wheel is a driven wheel that is driven by the driving wheel and in which the recesses are circumferential grooves.

The driven wheel is thus driven in rotation by the driving wheel only when the container for processing reaches the gap.

The invention also provides a device as defined above, wherein the value of the gap between the axes of rotation of the two wheels is adjustable.

This adjustment makes it possible to process containers of different types that vary both in terms of size and in terms of the mechanical characteristics of their general structure, and also to process different types of content that vary in terms of their viscosities and their behaviors.

The invention also provides a device as defined above, wherein each wheel is constituted by a plurality of disks that are spaced apart from one another along the axis of rotation of the wheel, each space between two consecutive disks constituting a circumferential recess, wherein at least one of the disks is provided with radially projecting spikes, and wherein the two wheels are offset relative to each other in a direction parallel to their axes of rotation so that the spikes of a disk engage between two disks of the other wheel when they are in the gap.

The invention also provides a device as defined above, including a receptacle situated in register with the gap to collect by gravity the liquid that is extracted from the containers passing through the gap.

The invention also provides a device as defined above, including a sloping perforated wall interposed between the receptacle and the gap in order to receive each emptied container leaving the gap so as to direct it away from the receptacle, while allowing the extracted liquid to pass through the perforations.

The invention also provides a device as defined above, wherein the axis of rotation of the driving wheel is situated higher than the axis of rotation of the driven wheel, and including a generally semicylindrical guide surrounding a bottom portion of the driving wheel in order to bring towards the gap each container that is introduced into the top portion of the guide.

The invention also provides a device as defined above, further including at least one fixed comb having one end engaged in a wheel having spikes, each tooth of the comb being engaged between two disks of the wheel.

The invention also provides a device as defined above, including firstly a comb positioned to separate a container from a wheel after passing through the gap and secondly a cleaning comb.

### BRIEF DESCRIPTION OF THE FIGURES

FIG. 1 is a diagrammatic side view of a device of the invention.

FIG. 2 is a diagrammatic plan view of the device of the invention.

FIG. 3 is a diagrammatic side view of the device of the invention.

### DETAILED DESCRIPTION OF THE INVENTION

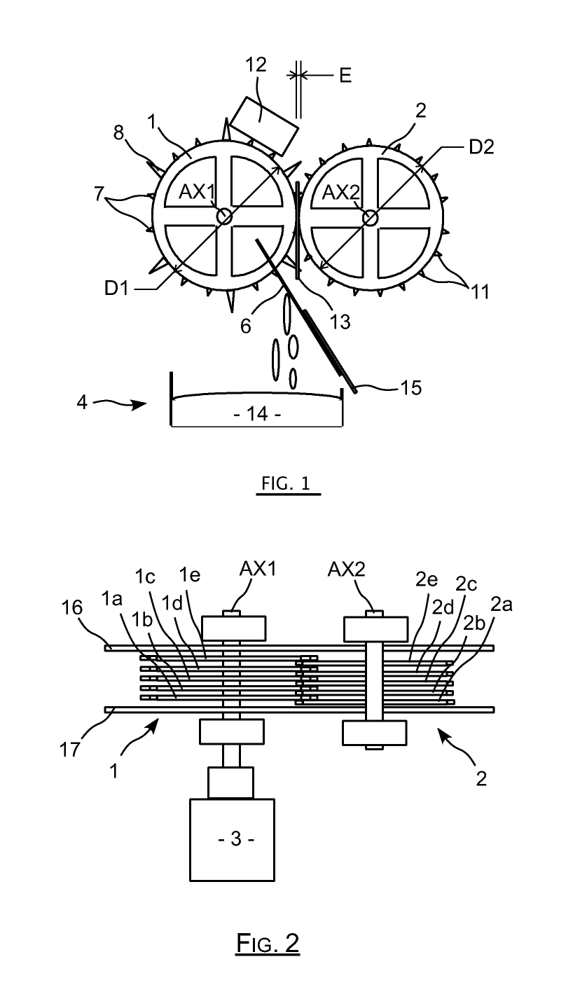

As can be seen in FIGS. 1 and 2, the device of the invention comprises a driving wheel 1 rotating about an axis AX1 adjacent to a driven wheel 2 rotating about another axis AX2 parallel to the axis AX1. These two axes are situated in the same horizontal plane, the driving wheel being driven to rotate directly by a motor referenced 3.

Each of these two wheels has a respective base diameter written D1 and D2, and they are spaced laterally apart from each other by a gap zone written E of value that is adjustable. The axes AX1 and AX2 are thus spaced apart by a distance given by E+½ (D1+D2), the gap zone being situated in the plane containing the axes AX1 and AX2. Optionally, the gap may be adjusted to have a value that is negative.

The device also includes a receptacle 4 that serves to receive the substance extracted from the containers being processed, the receptacle 4 being situated below the gap E so that the substance extracted from a container passing through the gap flows naturally into the receptacle.

A perforated wall or comb, referenced 6, is interposed between the gap zone E and the receptacle 4, and it is inclined so as to direct a solid container coming from the gap away from the receptacle 4.

As can be seen in the figures, the driving wheel has spikes referenced 7 extending radially away from the axis AX1 so as to go beyond the base diameter D1, thus serving to pierce or lacerate a container while it is being processed as it passes through the gap zone E.

The driving wheel 1 also has radial drive lugs, referenced 8, that are also radially oriented away from the axis AX1 in order to project beyond the base diameter D1 by a length that is greater than that of the spikes 7. These drive lugs 8 serve to facilitate directing containers for processing that are placed on the top portion of the driving wheel, so that they go towards the gap zone E.

As can be seen in the figures, around the axis AX1, the wheel has a larger number of spikes 7 than it has drive lugs 8. The driven wheel 2 does not have any lugs, but in analogous manner to the driving wheel 1 it does have spikes, which spikes are referenced 11 and project radially from its base diameter D2.

As shown in FIG. 2, each wheel is constituted by a stack of disks that are spaced apart from one another along the axis about which they extend. Thus, the driving wheel 1 is constituted by a series of five disks 1a to 1e that are spaced apart from one another. Each disk 1a-1e has a base diameter corresponding to the base diameter of the wheel, and has a plurality of drive lugs and a plurality of spikes that project radially beyond said diameter.

In analogous manner, the driven wheel 2 is likewise made up of a series of disks, referenced 2a to 2e, which disks are spaced along a shaft of axis AX2 that carries them, each disk having a plurality of spikes 11.

These disks are advantageously fabricated by being cut out from sheet metal, and the spacing between two consecutive disks along the axis about which they extend has a value that is slightly greater than the thickness of the sheet metal from which the disks are made. Furthermore, as can be seen in FIG. 2, the two wheels 1 and 2 are offset relative to each other along the direction of the axes AX1 and AX2 by an amount lying between the thickness of the disks and the spacing between consecutive disks.

Thus, the spaces between consecutive pairs of disks constitute circumferential recesses, i.e. hollow portions or setbacks towards the axis of rotation, in which the spikes and the lugs are received when they pass through the gap zone E. Consequently, although the spikes and the lugs project radially beyond the base diameter, they do not disturb rotation of the wheels.

Furthermore, because of this construction of the wheels in the form of stacks of disks, the two wheels can interpenetrate each other a little so as to impart greater compression on the containers being processed, it thus being possible to adjust the value of the gap E so as to give it a value that is negative.

Concerning the comb-shaped perforated wall 6, its top end advantageously has teeth that are spaced apart from one another by the same spacing as separates the consecutive disks. Thus, the top end of the wall 6 is engaged in the driving wheel 1 such that each tooth of said top end is interposed between two consecutive disks so as to ensure continuous cleaning of the wheel while the device is in operation.

In operation, the driving wheel 1 turns clockwise in FIG. 1 while the driven wheel turns in the opposite direction, i.e. counterclockwise, so that a container placed in the top portion of the wheels is led into the gap E.

In practice, each container that is to be processed, such as the container referenced 12, is placed on the top portion of the driving wheel 1 which is the wheel having the drive lugs 8.

Because of the rotation of the wheels 1 and 2, the container is taken towards the gap zone E where it is compressed by the wheels having their base diameters spaced apart from each other by the value of the gap E, which value is very small compared with the dimensions of the container being processed, which container in the gap zone is given the reference 13. Simultaneously, the spikes 7 and 11 pierce and lacerate the container 13 from its two opposite faces.

Under such conditions, the substance contained in the container 13 is extracted via the holes made by the spikes and under the effect of the compression produced by passing through the gap. This liquid 14 then flows under the effect of gravity towards the receptacle 4 while passing through the comb-shaped perforated wall 6.

Once the processed container has passed completely through the gap, it drops onto the sloping wall 6, this corresponding to the situation of the container that is referenced 15, and slides along the sloping wall 6 so as to be directed away from the receptacle 4.

As can be seen in FIG. 1, the end of the sloping wall 6 that has its teeth engaged in the bottom portion of the driving wheel 1 penetrating between consecutive disks serves to collect any extracted substance that might remain between the consecutive disks 1a-1e by an adhesion effect, so that the substance lies along the wall and drops into the receptacle 4.

In addition, the apparatus includes two cheekplates referenced 16 and 17 that are situated on either side of the two wheels 1 and 2 and that prevent the substance that is extracted in operation from being projected sideways.

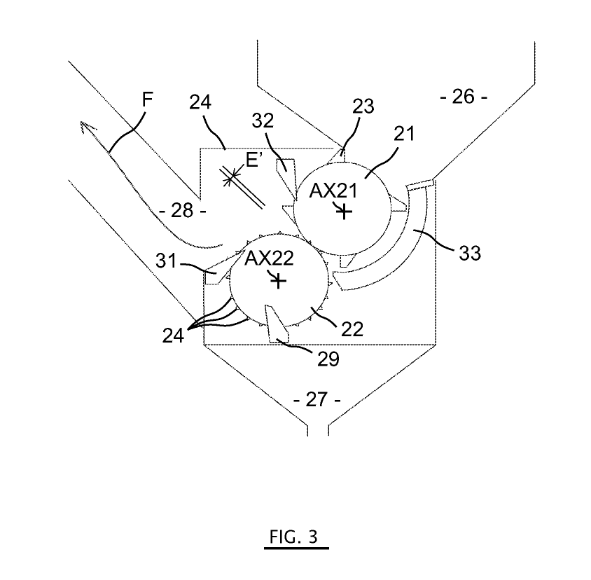

FIG. 3 shows a variant of the device of FIGS. 1 and 2 having a configuration that serves to reduce the quantity of extracted substance that remains on the outside face of the container.

In this variant, the apparatus likewise comprises a driving wheel and a driven wheel that are referenced 21 and 22 and that rotate about respective parallel axes referenced AX21 and AX22, the wheels being separated from each other by a gap E′.

The driving wheel 21 includes drive lugs 23 at its periphery that project beyond its base diameter, and the driven wheel 22 includes spikes 24 at its periphery for piercing the containers to be processed, and that also project radially beyond the base diameter of the driven wheel 22.

As in the example of FIGS. 1 and 2, the axes AX21 and AX22 of the wheels 21 and 22 are spaced apart from each other by a value corresponding to half the sum of the base diameters of said wheel plus a gap value E′.

Furthermore, and in analogous manner to that shown in FIGS. 1 and 2, the wheels 21 and 22 are offset from each other along the direction of the axes AX21 and AX22 by a distance that lies between the thickness of the metal sheet of the disks and the spacing of said disks. The spaces between the disks likewise constitute hollow portions or setbacks enabling the spikes to be engaged therein so as to avoid disturbing rotation when the spikes pass through the gap E′.

Unlike the variant of FIGS. 1 and 2, in this variant, the axis AX21 of the driving wheel is situated above the axis AX22 of the driven wheel, and the containers being processed are inserted via the bottom portion of the gap E′ so as to leave via the top portion of said gap.

Furthermore, the apparatus in this variant includes a covering or casing 25 that surrounds the wheels 21. The casing has a top portion 26 in the form of a hopper above the driving wheel 21, and through which the containers for processing are inserted. It has a bottom portion 27 in the form of a funnel for collecting the extracted substance, and also a side duct 28 opening out beside the driven wheel 21 for extracting the processed containers.

In addition, various stationary combs 29, 31, and 32 are provided that are of the same type as the top end of the perforated sloping wall in the example of FIGS. 1 and 2. These combs have their teeth engaged between the disks constituting the driving wheel and the driven wheel so as to clean them while they are in operation.

In operation, the driving wheel 21 turns clockwise in FIG. 3 and the driven wheel 22 turns counterclockwise. The containers for processing as inserted via the hopper 26 are driven by the driving wheel 21 having drive lugs 23 so as to be engaged in a channel C that is defined between said wheel and a semicylindrical guide 33 running around the lower right-hand portion of said wheel.

Each container is thus taken towards the bottom portion of the gap E′ where, in manner analogous to that shown in FIGS. 1 and 2, it is compressed merely by passing between the wheels, while also being pierced by the short spikes 24 of the driven wheel, thereby causing the substance to be extracted.

During extraction, the substance runs down into the funnel 27 from which it is recovered by collector means (not shown). Once all of the container has passed through the gap E′, it penetrates naturally via the top portion of the gap E′ onto the top portion of the driven wheel, which rotates counterclockwise so as to bring it to the mouth of the extraction duct 28 after being separated by the comb 31.

Thus, in this configuration, and unlike that of FIGS. 1 and 2, the container does not slide along a perforated surface through which the extracted substance passes, thereby significantly reducing the quantity of residual extracted substance that becomes deposited on the outside face of the processed container.

Furthermore, the device includes a rigid bar 34 extending parallel to the axes AX21 and AX22 of the wheels, being situated at the top end of the guide 33 at a relatively short distance from the ends of the lugs 23 so as to define the top opening of the channel C.

It is spaced apart from the base diameter of the wheel 21 by a distance that is both less than the greatest base dimension of a pack of containers for processing, and greater than the greatest sectional dimension of a container of the pack.

The term “pack” is used herein to designate a plurality of containers clamped together in common packaging such as a wrapping of thermoformed plastics material.

This bar serves to tear the plastics wrapping of the pack so as to further reduce the amount of handling work that is needed from the operator of the device.

In practice, when a pack of containers is engaged in the hopper 26, it spontaneously takes up a position such that the bottom face of its base bears against the bar 34, with the flank of the pack then extending along the top portion of the periphery of the wheel 21.

In this situation, the lugs 23, whose ends are advantageously pointed, cut or lacerate the wall of the plastics wrapper of the pack against the bar 34 on which the pack is bearing via its base. This releases the containers from the pack which are then naturally taken by the following lugs 23, and with the help of the guide 33, they are taken on to the gap E′ where they are processed.

What is claimed is:

1. A device for extracting a liquid or pasty substance (14) contained in a container (12, 13, 15) of non-brittle material, such as a container containing a cosmetic or food product, the device comprising two wheels (1, 2; 21, 22) rotating about parallel axes (AX1, AX2; AX21, AX22) while being separated from each other by a gap (E; E′), motor means (3) for driving these two wheels (1, 2; 21, 22) in rotation in opposite directions, at least one of the wheels (1, 2; 22) including spikes (7, 11; 24) that project radially, the other wheel (2, 1; 21) having recesses constituting hollow portions for receiving the spikes when they are in the gap (E; E′), thereby together compressing and piercing each container (12, 13, 15) passing through the gap (E; E′).

2. A device according to claim 1, wherein one of the wheels (1; 21) is a driving wheel that is driven directly by the motor means (3), and the other wheel (2; 22) is a driven wheel that is driven by the driving wheel (1; 21) and in which the recesses are circumferential grooves.

3. A device according to claim 1, wherein the value of the gap (E; E′) between the axes of rotation (AX1, AX2; AX21, AX22) of the two wheels (1, 2; 21, 22) is adjustable.

4. A device according to claim 1, wherein each wheel (1, 2; 21, 22) is constituted by a plurality of disks (1a-1e, 2a-2e) that are spaced apart from one another along the axis of rotation (AX1, AX2; AX21, AX22) of the wheel, each space between two consecutive disks constituting a circumferential recess, wherein at least one of the disks (1a-1e, 2a-2e) is provided with radially projecting spikes (7, 11; 24), and wherein the two wheels are offset relative to each other in a direction parallel to their axes of rotation (AX1, AX2; AX21, AX22) so that the spikes (7, 11; 24) of a disk (1a-1e, 2a-2e) engage between two disks (2a-2e, 1a-1e) of the other wheel when they are in the gap (E; E′).

5. A device according to claim 1, including a receptacle (4; 27) situated in register with the gap (E, E′) to collect by gravity the liquid (14) that is extracted from the containers passing through the gap (E; E′).

6. A device according to claim 1, including a sloping perforated wall (6) interposed between the receptacle (4) and the gap (E) in order to receive each emptied container (15) leaving the gap so as to direct it away from the receptacle (4), while allowing the extracted liquid (14) to pass through the perforations.

7. A device according to claim 1, wherein the axis of rotation (AX21) of the driving wheel (21) is situated higher than the axis of rotation (AX22) of the driven wheel (22), and including a generally semicylindrical guide (33) surrounding a bottom portion of the driving wheel (21) in order to bring towards the gap (E) each container (12, 13, 15) that is introduced into the top portion of the guide.

8. A device according to claim 1, further including at least one fixed comb (6; 29, 31, 32) having one end engaged in a wheel (1, 2; 21, 22) having spikes, each tooth of the comb being engaged between two disks (1a-1e, 2a-2e) of the wheel.

9. A device according to claim 8, including firstly a comb (31) positioned to separate a container from a wheel after passing through the gap (E) and secondly a cleaning comb (6; 29, 32).
